(19) United States
(12) Patent Application Publication
(10) Pub. No.: US 2014/0222499 A1
(43) Pub. Date: Aug. 7, 2014

(54) System and method of integrating plurality of customer care service centers for registering and tracking customer requests using one single platform

(71) Applicants: Balakrishna Dixit, Ashburn, VA (US); Tapas Dixit, Bangalore (IN)

(72) Inventors: Balakrishna Dixit, Ashburn, VA (US); Tapas Dixit, Bangalore (IN)

(21) Appl. No.: 13/759,074

(22) Filed: Feb. 5, 2013

(51) Int. Cl. G06Q 30/00

(52) U.S. Cl. CPC G06Q 30/016
USPC 705/7.29; 705/304

(57) ABSTRACT

The present invention provides a system and method of integrating plurality of customer care service centers for registering and tracking customer requests using one single platform to address products or service related issues with the customers. The system acts as a single point of contact for the customers to register and track complaints or issues with multiple customer care service centers of various products or service providers which are owned and used by the customer. The system completely eliminates the manual intervention at the back end i.e. on the customer care service centre during the time of registering a new complaint. The invention provides automation of raising/tracking complaints for multiple services provided to the customer by multiple service providers and avoids manual intervention from the customer care service centers where a customer care representative comes in to log a complaint or provide details for an existing complaint.

### PRIORITY CLAIM

This application the benefit under 35 U.S.C. §119 (b) of an application entitled “System and method of integrating plurality of customer care service centers for registering and tracking customer requests using one single platform” filed with Indian Patent Office, Chennai on Nov. 29, 2012 and assigned an application No. 4974/CHE/2012, the entirety of which is expressly incorporated herein by reference.

### DESCRIPTION OF THE INVENTION

The following specification particularly describes the invention and the manner in which it is to be performed:

### TECHNICAL FIELD OF THE INVENTION

The present invention relates to system and method for integrating plurality of customer care service centers for registering and tracking customer requests using one single platform which provides a single point of contact for the customers to register and track complaints/issues to multiple customer care service centre of different products and service providers which are used by the customer.

### BACKGROUND OF THE INVENTION

Each household in present days normally have electrical/electronic appliances from more than one provider/manufacturer; broadband and mobile services from more than one provider; vehicles from more than one manufacturer and many more products/services purchased or consumed. The conventional process for a customer/user of a service to report a complaint to the customer care service of a product or a service is either through making a call to the customer care service centre or via logging into customer care service portal/website and register the complaint. In the first method, the customer who wants to lodge a complaint calls the customer care service telephone numbers provided by the product manufacturer/service provider and explains the problem details. This process has a number of problems such as in order to access the call a customer care from a telephone, the customer has to keep different phone numbers of various product/service handy before making a call as there is a different phone number for each one of them. While making a call, the customer has to pass through various menu options before reaching menu as per his requirement. At times, the customer has to wait for a while before connecting the customer care executive. Moreover, upon connecting to the customer care executive, the customer has to provide own verification details and describe the complaint which makes the conventional system a painful and time consuming task. In order to track the previously filed complaint, the same steps are to be repeated before connecting to the customer care executive. Sometimes while the customer is half way through explaining the problem to the customer care executive, the call gets disconnected. In these situations, the customer has to redial again and start explaining again since the customer gets connected to some other representative. The customer needs to store different customer care telephone numbers in his/her telephone. Irrespective of the telephone's capability and features the telephone customer has to undergo this inefficient process.

In the second method, the customer has to log into a customer care service portal/website to register a complaint associated with a particular product/service. This system also has a number of drawbacks such as the customer has to first keep a note of website for each of the product/services and access the customer care from the service provider's web site. In this process, the customer has to visit different customer care web site for each product/service. Moreover, in order to register a complaint through the interactive portal the customer needs to be a registered customer and needs to remember the registration customer ID and passwords.

Apart from the above mentioned problems faced by the customers, the organizations that offer customer care service centre also needs to employ the customer care representatives whose role is to answer the customer calls and log in requests in the system which means extra financial burden/cost to the company.

Hence what is needed is a system that integrates various customer care service centers and allows a customer to register and track complaints and queries using one single platform

### SUMMARY OF THE INVENTION

The present invention provides a system and method for integrating plurality of customer care service centres for registering and tracking customer requests using one single platform. The system mainly comprises a two way interactive portal having graphical user interface. The portal is connected to a plurality of customer care service centres via network for direct communication between a customer and the plurality of customer care service centres wherein the portal facilitates the registration and tracking of requests from the customers wherein the requests relate to products, services or event businesses owned by a customer. The request from the customer mainly includes registration of a new complaint to the customer care service centre by the customer, tracking of complaint previously registered by the customer or sending a general query regarding a product or service by the customer. In one embodiment, the customer may post the complaint to the social media platform after registering a complaint with the customer care service centre.

The system also includes a customer repository which is connected to the system for storing details of the customer, product details and communication details between the customer and the plurality of customer care service systems. The customer repository stores details related to the products owned by the customer wherein the details related to the product are specific to each product. A forms repository is connected to the system for storing a form specific to each customer care service centre. Through the system, the customer is enabled to directly communicate with plurality of customer care service centre without the need of individually interacting with each customer care service centre for various products and services related complaints and queries. In this embodiment, the customer has to register himself/herself to the system by providing customer details wherein customer details further comprise customer's name, customer's address, customer's date of birth or customer's contact number etc wherein customer details are stored in the customer repository. The customer care service centres participating in the system provide a form specific to the customer care service centre for each request wherein the form is used while transmitting customer request to relevant customer care service system. While transmitting the customer request to the customer care service systems, the form is filled automatically with customer details and product details whereby eliminating the efforts of contacting the different customer care centres for each product and explaining the product details and associated issues etc. which enables the customers with hassle free interaction with various customer care service centres using single platform. After transmitting the request, a unique reference ID is generated by the customer care service centre and sent to the customer through the portal. The customer care service centre verifies the request and transmits the request status to the customer. The customer repository stores request's reference ID, product details and status of the complaint for each communication between the customer and the customer care service system.

In one embodiment, a plurality of sellers of products/services are connected to the system wherein the retailer/seller provides the customer details using the portal and submits to the platform. The system further includes a business intelligence layer to conduct analytics work on records from end customer repository and forms repository wherein the analytics are used for at least one of determining the most popular and least popular products or services among customers, determining the products or services having largest incidence of complaints and issues for easy charting of the trends among various categories of the customers, determining the buying behaviour of customers belonging to a particular geography, location or demography, designing and developing new product/service ideas based on the analytics, up selling to the customers, or providing incentives to the customers for being loyal.

In one embodiment, the system may be implemented as a computer application wherein the computer application is used by the customer to connect to the system interacting with various customer care service centers through the network.

In another embodiment, the system may be implemented as an interactive portal wherein the customer accesses the system using web browser to register, raise and track the previously filed complaints.

The computing device includes any device having computing capabilities and a display such as a computer, tablet, smart phone, smart watch, smart camera and smart television.

Since the invented system allows a customer to register himself/herself before using the system, it avoids the time consuming task of validating oneself whenever a call is made or whenever the customer connects to the system to register or track a complaint. The customer need not verbally explain and talk to the customer care representative whenever the customer raises new complaints. The customer just needs to write down the complaint details in customer care service centre specific form and submit the form to the platform. The platform receives up the form and forwards it to the relevant service provider's customer care service centre. Many fields of the form are dynamically filled by the platform because the platform stores the customer details such as name, address etc. and also the product or service details which the customer owns in a customer database. While tracking a previously registered complaint, the customer just needs to select the desired complaint ID from a list which makes the tracking process easier. This in turn increases the customer satisfaction and also the time and pain to interact with different customer care service centers decreases a lot as the customers need not login to different service provider's website or call toll free numbers.

The usage of the present system reduces the overall number of customer care representatives which the service provider employs may be reduced because the manual intervention is avoided or minimized which means lesser financial outflow burden for the organization and less manpower management.

In the present system, the customer details such as different electrical/electronic appliances in his house and other services subscribed by the customer are stored in the platform. This information may be used by organizations and analysts to study buying behavior, complaint trends and various kinds of analytics that may help organizations develop new products or have product launches on specific markets by geography or demographics. It may spawn further product and service research and development.

It is to be understood that both the foregoing general description and the following details description are exemplary and explanatory and are intended to provide further explanation of the invention as claimed.

### BRIEF DESCRIPTION OF THE DRAWINGS

The foregoing and other features of embodiments are more apparent from the following detailed description of embodiments when read in conjunction with the accompanying drawings. In the drawings, like reference numerals refer to like elements.

FIG. 1 shows the block diagram of the system for integrating plurality of customer care service centers for registering and tracking customer requests using one single platform, according to an exemplary embodiment of the invention.

FIG. 2a illustrates an exemplary graphical user interface of the portal presented to the customer while giving details of the owned products and services from a computing device according to an exemplary embodiment of the invention.

FIG. 2b illustrates an exemplary graphical user interface of the interactive portal presented to the customer while registering to the platform for the first time from a computing device, according to an exemplary embodiment of the invention.

FIG. 2c illustrates an exemplary graphical user interface of the portal presented to the customer while providing details of the owned products or services from a computing device, according to an exemplary embodiment of the invention.

FIG. 2d illustrates an exemplary graphical user interface of the portal presented to the customer after the customer registers with the platform, according to an exemplary embodiment of the invention.

FIG. 3 illustrates the process flow of the method of registering and tracking product related requests with plurality of customer care service centers using one single platform, according to an exemplary embodiment of the invention.

FIG. 4a illustrates an exemplary graphical user interface of the portal presented to the customer while registering a new complaint, according to an exemplary embodiment of the invention.

FIG. 4b illustrates an exemplary graphical user interface of the portal presented to the customer upon selecting the option to register a new complaint, according to an exemplary embodiment of the invention.

FIG. 4c illustrates an exemplary graphical user interface of the portal presented to the customer upon selecting the product or service while registering a complaint, according to an exemplary embodiment of the invention.

FIG. 4d illustrates an exemplary graphical user interface of the portal presented to the customer upon registering a complaint to a customer care service centre, according to an exemplary embodiment of the invention.

FIG. 4e illustrates the process flow of the method of registering a new complaint with a customer care service centre, according to an exemplary embodiment of the invention.

FIG. 5a illustrates an exemplary graphical user interface of the portal presented to the customer for tracking a previously submitted complaint to a customer care service centre, according to an exemplary embodiment of the invention.

FIG. 5b illustrates an exemplary graphical user interface of the portal presented to the customer while tracking a previously submitted complaint to a customer care service centre, according to an exemplary embodiment of the invention.

FIG. 5c illustrates an exemplary graphical user interface of the portal presented to the customer upon receiving request status of an already submitted complaint, according to an exemplary embodiment of the invention.

FIG. 5d illustrates an exemplary graphical user interface of the portal presented to the customer for escalating the complaint, according to an exemplary embodiment of the invention.

FIG. 5e illustrates the process flow of the method of tracking a previously registered complaint with a customer care service centre, according to an exemplary embodiment of the invention.

FIG. 6a illustrates an exemplary graphical user interface of the portal presented to the customer for registering a new query with a customer care service centre, according to an exemplary embodiment of the invention.

FIG. 6b illustrates an exemplary graphical user interface of the portal presented to the customer after selecting the query option, according to an exemplary embodiment of the invention.

FIG. 6c illustrates an exemplary graphical user interface of the portal presented to the customer after selecting the query option, according to an exemplary embodiment of the invention.

FIG. 6d illustrates the process flow of the method of sending a general query regarding a product by the customer, according to an exemplary embodiment of the invention.

FIG. 7 illustrates an exemplary graphical user interface for enabling retailer/sellers access the system, according to an exemplary embodiment of the invention.

FIG. 8 illustrates block diagram of the business intelligence layer according to an exemplary embodiment of the invention.

### DETAILED DESCRIPTION OF THE INVENTION

Reference will now be made in detail to the description of the present subject matter, one or more examples of which are shown in figures. Each example is provided to explain the subject matter and not a limitation. Various changes and modifications obvious to one skilled in the art to which the invention pertains are deemed to be within the spirit, scope and contemplation of the invention.

The term ‘customer’ means and includes a client, buyer, or purchaser who is the recipient of a good, service, product, or idea, obtained from a seller, vendor, or supplier for a monetary or other valuable consideration or as a gift etc.

The term ‘products’ means and includes any tangible or non tangible product, service, event, gift etc.

The term ‘customer care service centers’ means and includes customer care services centers provided by various products, services, events businesses or any kind of for-profit or not-for-profit businesses.

The present invention provides an intermediate platform to address products or service related issues with the customers and acts as a single point of contact for the customers to register and track complaints or issues with multiple customer care service centers of various products or service providers which are owned and used by the customer. The system completely eliminates the manual intervention at the back end i.e. on the customer care service centre during the time of registering a new complaint. The invention provides automation of raising/tracking complaints for multiple services provided to the customer by multiple service providers and avoids manual intervention from the customer care service centers where a customer care representative comes in to log a complaint or provide details for an existing complaint.

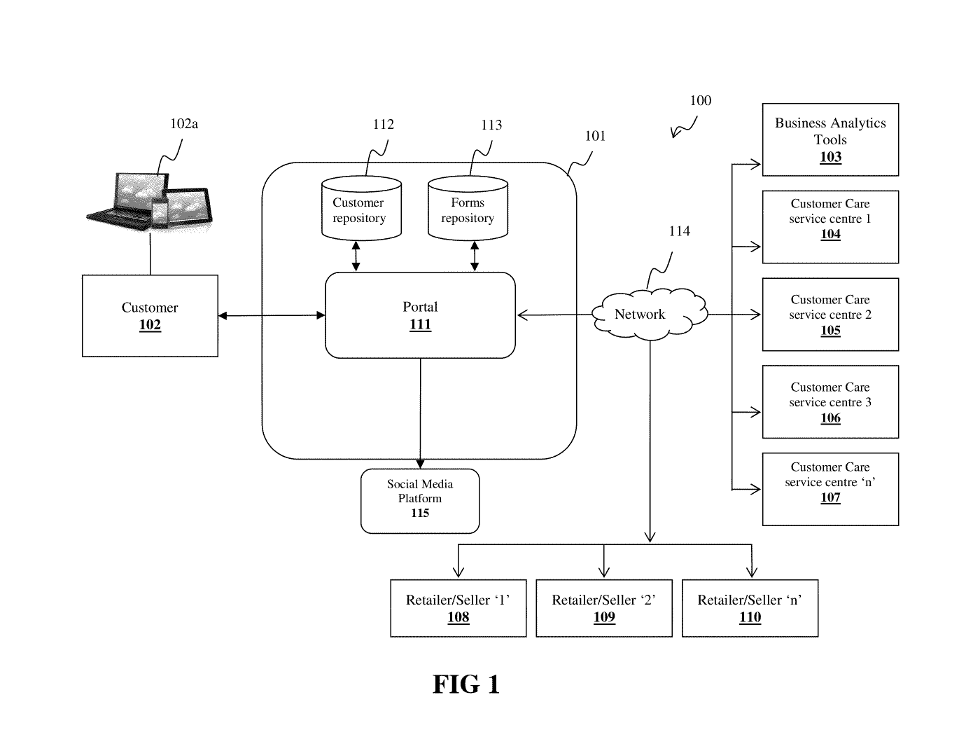

FIG. 1 shows the block diagram of the system for integrating plurality of customer care service centers for registering and tracking customer requests using one single platform, according to an exemplary embodiment of the invention. The present invention provides a system for integrating plurality of customer care service centers for registering customer requests using one single platform. The system mainly comprise a plurality of customer care service centers (104, 105, 106 or 107) connected to an integrated customer care service platform (101) via network (114), wherein the customer care service centers (104, 105, 106 or 107) provide customer care services related to products, services or event businesses owned by a customer. (For illustration purpose only four customer care service centers are provided though there may be more number of such customer care service centers connected to the platform). The system (100) integrates and connects multiple customer care service centers (104, 105, 106 or 107) provided by various product manufacturers or service providers to an integrated customer care service platform (101). The customer (102) connects to the platform (101) using a suitable computing device (102a) via network (114) to interact with all the relevant customer care service centers (104, 105, 106 or 107) and register a new complaint/issue or track previously registered complaints. Using the system, the customer (102) is enabled to directly communicate with plurality of customer care service centre (104, 105, 106 or 107) using a single platform without the need of directly interacting with each customer care service centre for various products and services related complaints and queries. The computing device (102a) may include any device having computing capabilities and a display such as a personal computer, tablet, smart phone, smart watch, smart camera, smart television etc. to connect to the platform (101) using internet connectivity.

The system also includes an Internet based two way interactive portal (111) having graphical user interface for enabling direct communication between the customer (102) and the plurality of customer care service centers (104, 105, 106 or 107). In exemplary embodiments, one or more portal (111) may be provided to enable service providers and customer to use various features of the platform. The portal (111) may include two way interactive portals having user interfaces such as websites, networked applications or application programming interfaces etc. The customer (102) may log in to the portal (111) using valid credentials which helps the customer (102) communicate with the customer care service centers.

Each of the customer care service centre (104, 105, 106 or 107) participating in the solution provide a form for various activities such as registering a new complaint and also a form for tracking a previously registered complaint and other relevant forms which may be used by the customer (102) to interact with various customer care service centre. Hence the system also includes a forms repository (113) connected to the portal (111) for storing pre formatted form specific to each customer care service centre of products/services/event businesses participating in the present system. The platform (101) interacts with various customer care service centre and collects the soft copies of the forms. These types of forms and any other form are collected from each of the participating customer care service centre and stored in the platform's form repository (113). For each customer care service centre a specific set of queries are stored in the platform's forms repository (113) or any relevant repository.

The customer (102) registers himself/herself with the platform (101) using the portal (111) while interacting with it for the first time and provides personal details such as name, address, DOB etc. The customer (102) also has to provide the product or service details which the customer (102) uses in his day to day life. This is a one-time activity. This information for each of the customer (102) registering to the system (100) is stored in the customer repository (112) which is connected to the portal (111). The customer repository (112) also stores the registered complaint details for each registered customer (102). Details such as complaint's reference ID, Product details, state of the complaint like resolved/pending etc. are stored in customer repository (112) for each complaint registered.

In one embodiment, the system also includes various sellers (108, 109, or 110) of various products or services which are integrated with the platform (101) wherein the sellers (108, 109, or 110) include various retailers as well that may connect and communicate to the platform (101), the details of the service or product purchased by a customer (102) along with other relevant customer details such as customer's mobile number, name, address etc. The platform (101) stores the customer (102) details and the product or service detail in the customer repository (112). This information is passed to the customer (102) when he/she wants to register a complaint for any product or service.

In one embodiment, the system also includes a business intelligence layer built around the platform (101) that extracts information from the platform (101) which may be used by the organizations and analysts to study buying behavior, complaint trends and various kinds of analytics. This information helps organizations develop new products or have product launches on specific markets based upon geographies or demographics which may spawn further product and service research and development.

In one more embodiment, the platform (101) may be integrated to the social media websites/platforms where the customer (102) may also post the details of the complaint/issue in social media platforms after logging a complaint in the customer care service centre. The platform (101) posts all the details related to the complaint such as product/service details, the customer details, and the complaint/reference ID on the customer care account of the social media.

In another embodiment, the interactive portal may be implemented as a mobile application which may be developed by the customer care service centers (104, 105, 106 or 107) for each of the available mobile platforms such as iOS, Android, Windows etc. These applications may be uploaded to the application market such as iOS market or android market. The customer (102) may connect the computing device (102a) to these online markets and download the mobile application and install on their computing device (102a). In this embodiment, a computing device such as a smart phone, tablet etc. may be used by the customer (102) to communicate with the platform (101) to register or track a complaint with the participating customer care service centre. While installing the mobile application the customer (102) may be prompted to enter a password which may be entered by the customer (102) for future usage to the mobile application. The customer (102) may connect the computing device (102a) using internet/3G/4G connectivity to the application market. For example, if the customer (102) has an android computing device (102a) he/she needs to access Google Play Store. Similarly, if the customer (102) has an Apple iPhone® or iPad®, he/she needs to access the iPhone® Market to download the mobile application. Once connected to the application market, the customer (102) may search for the specific mobile application developed and uploaded by the platform (101) in the application market to connect the computing device (102a) to the platform (101). The customer (102) may download the specific mobile application to the computing device (102a) and install the mobile application. While installing the computing device (102a) of the customer (102) may be directed by the application installer to enter a password which may be entered by the customer (102) for future usage of the application. In another embodiment, a web URL may be provided to the customer to connect to the platform (101) from web browsers installed in their computing devices (102a) in order to register and track requests such as complaints and queries etc.

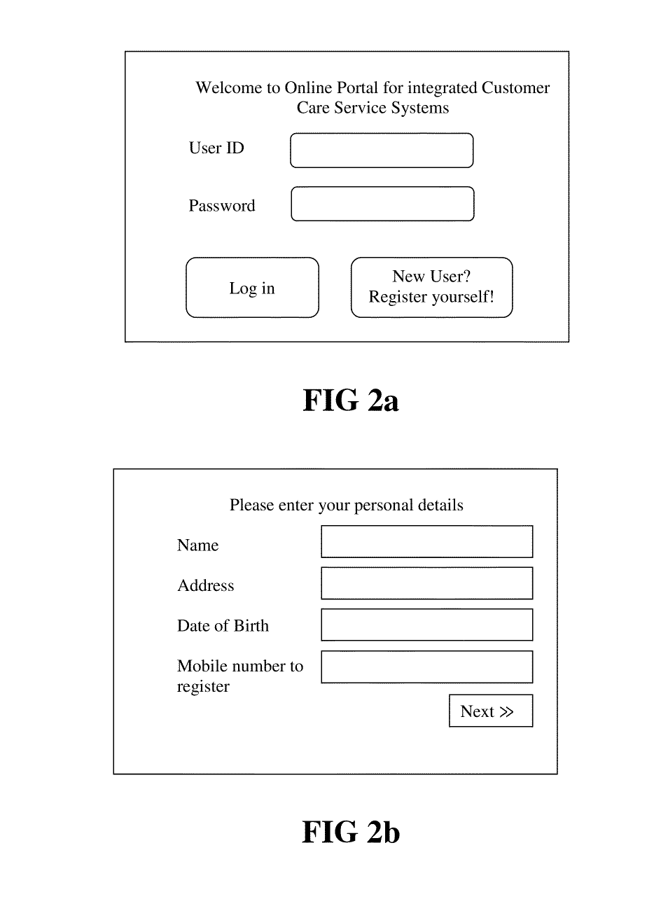

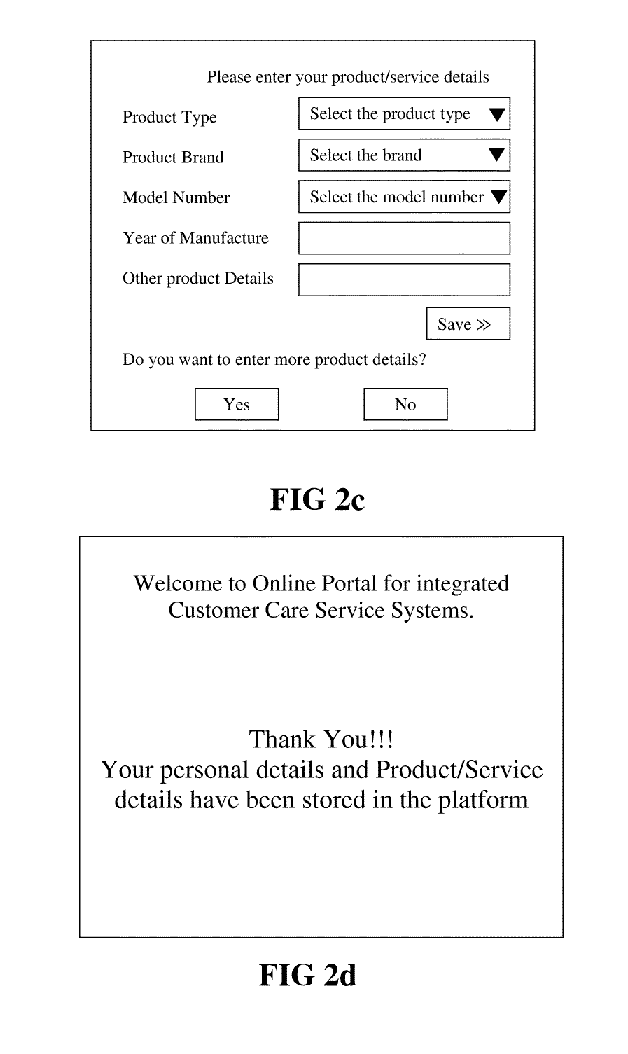

FIG. 2a illustrates an exemplary graphical user interface of the portal presented to the customer while giving details of the owned products and services from a computing device according to an exemplary embodiment of the invention. The portal (111) for accessing the platform (101) may be either web based portal that may be accessed using a web browser or may be a software application installed on the computing device (102a) of the customer (102). The FIG. 2a shows initial user interface presented to the customer (102) wherein customer (102) may log in to the portal (111) (in case registered already) or register afresh (in case not registered earlier). In case the customer (102) is a new customer and accessing the portal (111) for the first time, the customer (102) may click on the “New customer? Register yourself!” button. In case the customer (102) is already registered, he/she may login to the portal (111) using the login credentials wherein the customer (102) is directed to a page where the customer may enter the personal details like Name, Address, Date of Birth, preferable customer ID and password etc as shown in the figure.

FIG. 2b illustrates an exemplary graphical user interface of the interactive portal presented to the customer while registering to the platform for the first time from a computing device, according to an exemplary embodiment of the invention. Upon accessing the portal (111) for the first time, the customer (102) is required to provide personal details as well as the details of the products and services which the customer owns through a registration process as described here. In an exemplary embodiment, the first screen after opening the portal (111) for the first time may display a text such as “Welcome to XXX. Before raising or tracking a complaint please register with the platform”. If the customer (102) chooses to register with the platform (101), the portal (111) may provide a predefined form to be filled by the customer (102) (as shown in the FIG. 2a) with the title “Please enter your personal details”. It may contain many more details based on the requirements and information needed by the customer care service centre. The registration is a mandatory step for verifying the customer (102) by the customer care service centre. As shown in the FIG. 2b, the personal details may include some basic information such as name, address, date of birth or mobile number of the customer which the customer wants to register. The personal details may be stored in the platform's customer repository (112) which may be sent to the customer care service centers along with the complaint description while registering a new complaint, tracking of complaint previously registered or sending a general query regarding a product or service.

FIG. 2c illustrates an exemplary graphical user interface of the portal presented to the customer while providing details of the owned products or services from a computing device, according to an exemplary embodiment of the invention. After entering the personal details, the customer (102) is prompted to fill up the product/services details for which the customer wants to register or track a complaint with the customer care service centre in future. The product/service details are very specific to the information needed by each of the product/service provider and may vary from one product/service provider to another. The portal (111) may provide a list of fields such as product type, product brand, model number etc. to the customer (102) wherein the customer (102) may select from the list the products or service owned by him/her. Some more fields may be dynamically added to the list based on the selections made for a specific product type or for a particular model number etc. The system allows the customer (102) to enter the details of the products/services by scanning the product bar code using the digital camera of the computing device (102a), a bar code reader attached externally or through manual entry. This data is stored in the platform's customer repository (112). Once the product/service details are stored in the platform (101), the portal (111) displays to the customer (102), a list of products while raising a complaint to enable the customer (102) select from a drop down list, the product/service for which the customer (102) wants to register a complaint. The platform (101) collects the details and then creates a new entry in the customer repository (112) for each customer (102) who gets registered. The platform (101) adds a unique entry for each of the customers (102) willing to register with the platform (101). In the exemplary embodiment, the customer (102) is provided with the facility to input the details of more than one product at a time by prompting him/her to enter more product details as illustrated at the bottom of the user interface screen in the FIG. 2c.

FIG. 2d illustrates an exemplary graphical user interface of the portal presented to the customer after the customer registers with the platform, according to an exemplary embodiment of the invention.

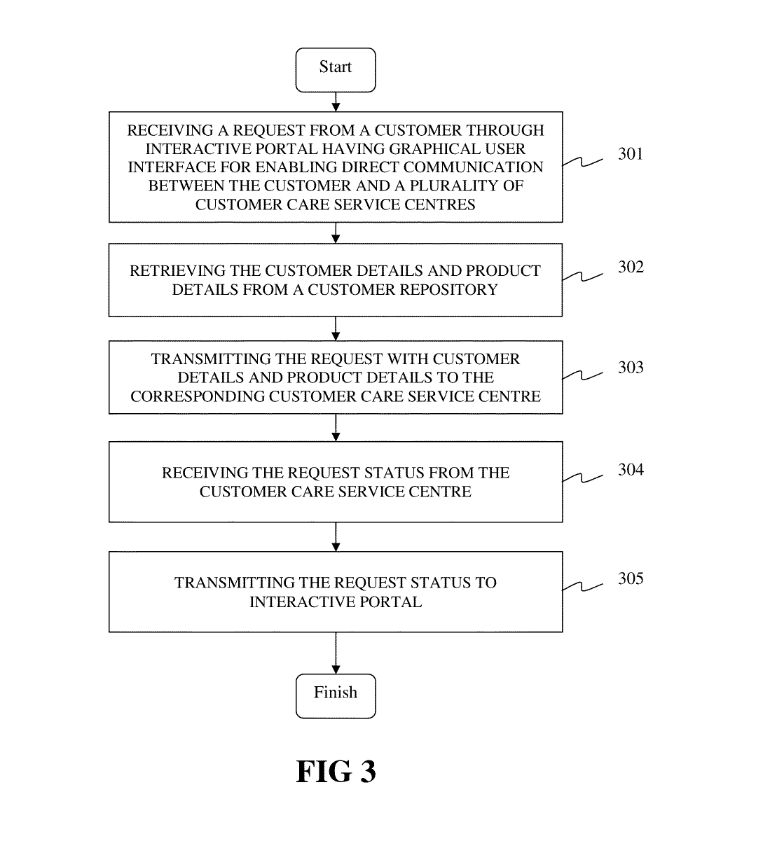

FIG. 3 illustrates the process flow of the method of registering and tracking product related requests with plurality of customer care service centers using one single platform, according to an exemplary embodiment of the invention. The process flow illustrated here describes the overall process flow of the system. The method allows a customer to directly communicate with plurality of customer care service centre using one single platform without the need of directly interacting with each customer care service centre related to various products and services. The method initiates at step 301, where a request is received from a customer through the interactive portal having graphical user interface for enabling direct communication between the customer and a plurality of customer care service centers wherein the request relates to the product owned by the customer. In one embodiment, a request comprises registering a new complaint to the customer care service centre by the customer, tracking a complaint previously registered by the customer or sending a general query regarding a product by the customer. The customer is required to registers himself/herself by providing customer details comprising customer's name, customer's address, customer's date of birth or customer's contact number. All the customer details are stored in the customer repository. At step 302, the customer details and product details are retrieved from a customer repository. The customer repository stores product related details wherein product related details are specific to each product. The term products also include services rendered by service providers which are availed by the customer. At step 303, the request with customer details and product details is transmitted to the corresponding customer care service centre. At step 304, the request status is received from the customer care service centre. At step 305, the request status is transmitted to the interactive portal to display on the user interface.

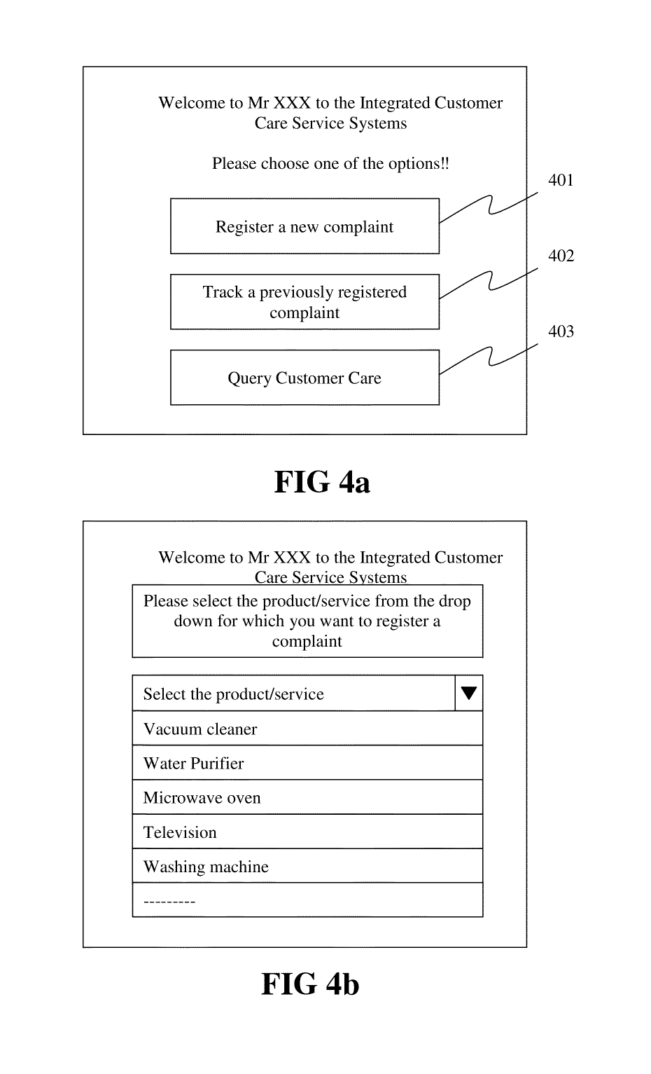

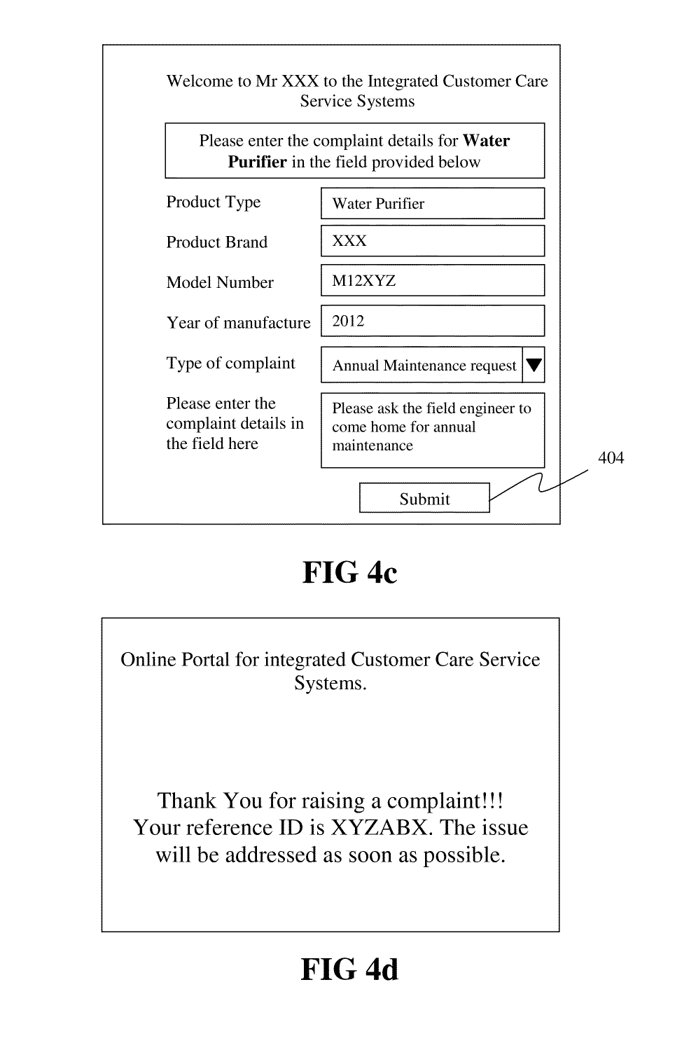

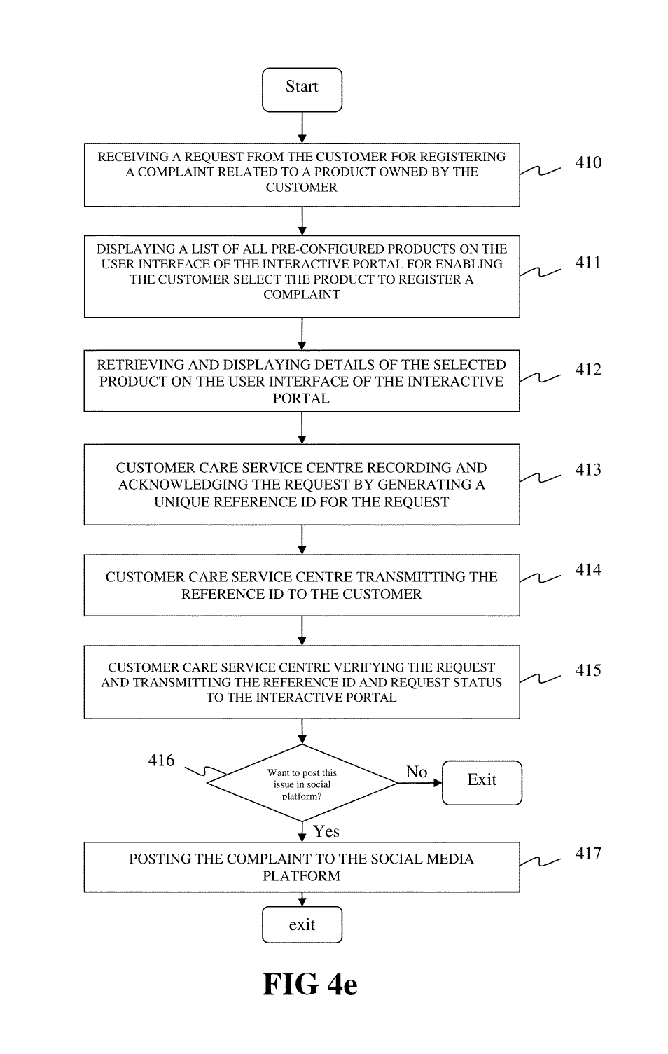

FIG. 4a illustrates an exemplary graphical user interface of the portal presented to the customer while registering a new complaint, according to an exemplary embodiment of the invention. After the customer logs in to the portal (111) or starts the mobile application, the customer is asked to select at least one option displayed on the user interface. In one embodiment, the displayed options may be provided in the form of button such as “Register a new complaint” button (401), “Track a previously registered complaint” button (402) and the “Query Customer Care” button (403). It should be noted that these are just exemplary options and there may be provided more options which may be added to the user interface.

FIG. 4b illustrates an exemplary graphical user interface of the portal presented to the customer upon selecting the option to register a new complaint, according to an exemplary embodiment of the invention. In case the customer selects the option “Register a new complaint” the customer is provided with a list of all the pre-configured products or services details stored in the platform's customer repository (112) as shown in the figure. The platform (101) sends the details to the customer whereby the portal (111) on the computing device (102) displays all the products and services details in the form of a drop down menu. The customer (102) may select the specific product or service for which he/she wants to register the complaint.

FIG. 4c illustrates an exemplary graphical user interface of the portal presented to the customer upon selecting the product or service while registering a complaint, according to an exemplary embodiment of the invention. As shown in the figure, upon selecting the product from the user interface, the application communicates with the platform (101) and automatically fetches the other stored details about the product such the product type, product name, model number, year of manufacture etc from the customer repository (112) of the platform (101). The fields such as product type, model number, year of manufacture etc are automatically filled with the details as entered by the customer while registering himself/herself to the portal (111) initially. Since all the product related details are automatically fetched from platform's customer repository (112), the customer is required to enter only the minimal information such as “Type of complaint” and “Complaint Description” etc. which reduces the efforts of contacting the customer care service centers and explaining the product and associated problems etc. The customer may submit the complaint to the platform using the submit button (404) on the user interface. The platform verifies the complaint request and forwards it to the relevant/specific customer care service centre in the predetermined format specified by each customer care service system.

FIG. 4d illustrates an exemplary graphical user interface of the portal presented to the customer upon registering a complaint to a customer care service centre, according to an exemplary embodiment of the invention. The customer care service centre, upon receiving the complaint records it in their system and generates a unique reference ID, retrieves the complaint status and relevant information for the each complaint. This information generated by the customer care service centre is transmitted to the platform and the platform transmits the information to the customer as shown in the figure.

FIG. 4e illustrates the process flow of the method of registering a new complaint with a customer care service centre, according to an exemplary embodiment of the invention. At step 410, a request is received from the customer through interactive portal for registering a complaint related to a product owned by the customer. At step 411, a list of all the pre-configured products or services is displayed on the interactive portal (111). The customer may select the product or a service from the list to register the complaint. At step 412, the product details are retrieved from the customer repository and displayed on the user interface of the interactive portal (111) wherein the user is allowed to input the complaint. Each customer care service centre provides a form with important fields relevant to the specific customer care system for each request wherein the form used while transmitting customer request to relevant customer care service centre. At step 413, the customer care service centre receives the request in pre defined forms and further records and acknowledges the request by generating a unique reference ID for the request. At step 414, the customer care service centre transmits the reference ID to the platform. At step 415, the customer care service centre verifies the request and displays the reference ID and request status on the user interface of the interactive portal (111). The customer repository stores request's reference ID, product details and status of the complaint for each communication between the customer and the customer care service centre. At step 416, the customer is given an option to post the issue to the social media platform using his/her social media account. If the customer says yes to post the complaint to the social media, an appropriate content is formed by including the product or service details, the complaint description, the complaint ID which the customer care system had generated. At step 417, all the content of the complaint is then posted to the social media platform using customer's user account in the social media platform.

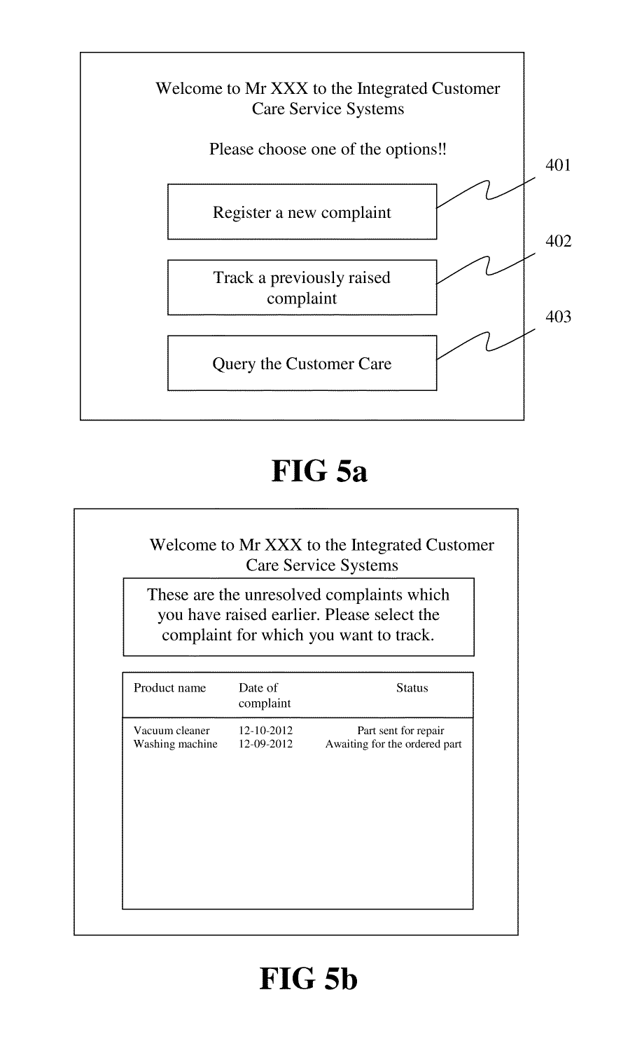

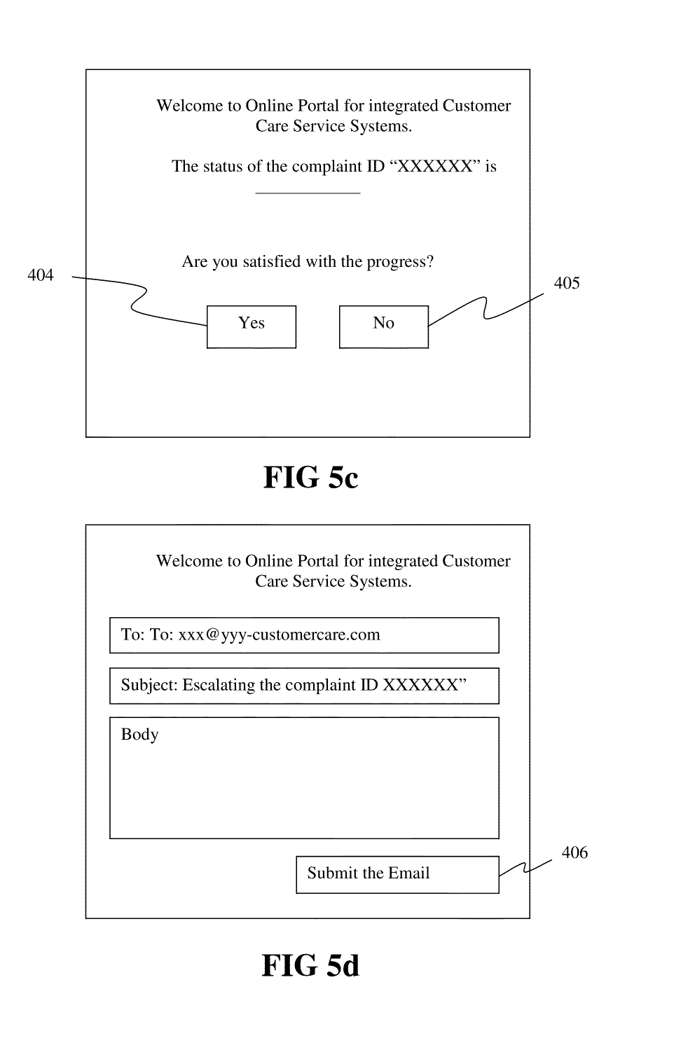

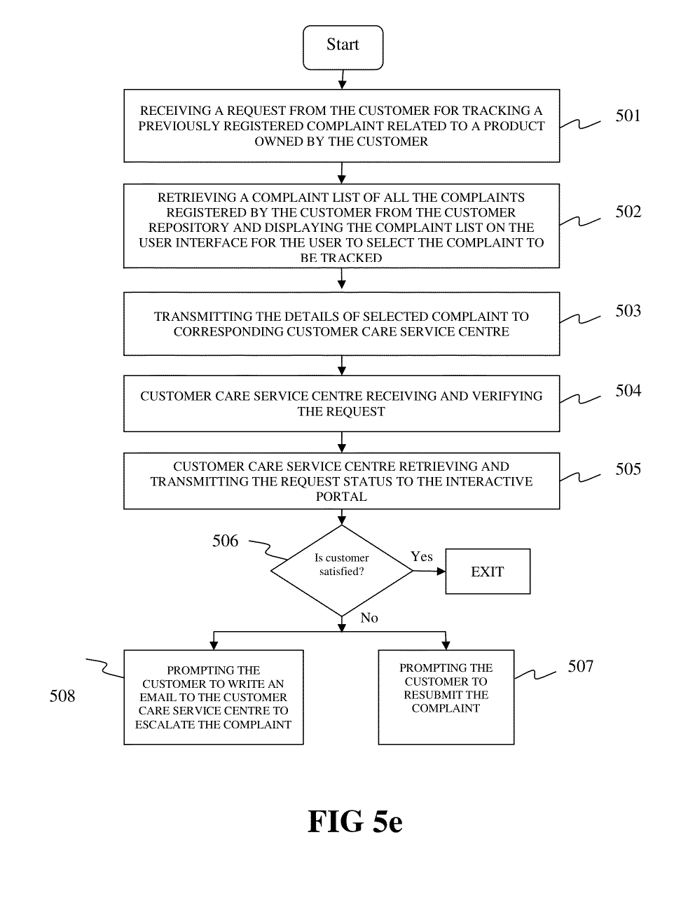

FIG. 5a illustrates an exemplary graphical user interface of the portal presented to the customer for tracking a previously submitted complaint to a customer care service centre, according to an exemplary embodiment of the invention. In this embodiment, the platform provides the facility to the registered customer to track a complaint submitted previously with a customer care service centre. Upon logging into the platform, the customer may select the “Track a previously registered complaint” button (402) provided on the user interface.

FIG. 5b illustrates an exemplary graphical user interface of the portal presented to the customer while tracking a previously submitted complaint to a customer care service centre, according to an exemplary embodiment of the invention. The portal retrieves the details of all recently registered and previous registered complaints from the customer repository and displays on the user interface as shown in the figure. The details of the complaints may include information such as reference ID allotted while registering the complaint, the product name for which the complaint was registered, the date of raising the complaint, and the latest status of the complaint. The customer may select the desired complaint to know about the further update on the complaint.

FIG. 5c illustrates an exemplary graphical user interface of the portal presented to the customer upon receiving request status of an already submitted complaint, according to an exemplary embodiment of the invention. When the customer selects a complaint from the user interface, the details of the complaint are transmitted by the platform to the corresponding customer care service centre for request status. The customer care service centre receives and verifies the request and then further retrieves the details about the progress of the complaint from their system. The request status is then transmitted to the customer via platform. The application displays the complaint status to the customer on the user interface as shown in the figure. The customer may be provided with an option to resubmit the complaint. If the customer is satisfied with the progress of the complaint he/she may select the ‘Yes’ button (404). In case the customer is not satisfied with complaint and wants to further escalate it to higher authorities he/she may click the ‘No’ button (405).

FIG. 5d illustrates an exemplary graphical user interface of the portal presented to the customer for escalating the complaint, according to an exemplary embodiment of the invention. The platform automatically extracts the email ID of the relevant customer care service centre and enters the subject line for an email to be sent to the higher authorities for escalating the already submitted complaint. If the customer wants to escalate it to higher authorities he shall be provided with an interface to write a mail to the concerned higher authority of the customer care. The customer may just click the “submit the email” button (406) whereby the platform transmits the email to relevant customer care for escalating the complaint.

FIG. 5e illustrates the process flow of the method of tracking a previously registered complaint with a customer care service centre, according to an exemplary embodiment of the invention. In case the customer has previously registered a complaint, he/she may track the request status using the method explained below. At step 501, a request is received from the customer for tracking a previously registered complaint related to a product owned by the customer. At step 502, a complaint list of all the complaints registered by the customer is retrieved from the customer repository and the complaint list is displayed on the user interface for the user to select the complaint to be tracked. At step 503, the details of the selected complaint are transmitted to the corresponding customer care service centre. The details may include the name of the product, reference ID assigned to the complaint while registering and the type of problem etc. At step 504, the customer care service centre receives and verifies the request. At step 505, the customer care service centre retrieves the status of the complaint and transmits the request status to the customer which is displayed on the user interface of the portal. At step 506, it is checked whether the customer is satisfied with the status update or not. In case the customer selects the yes option, the method terminates whereas in case the customer selects no options, which means that the customer is not satisfied and wants to have a further inquiry or wants to escalate the process, the method proceeds to the next step where the customer is prompted either to resubmit the complaint at step 507 or is prompted to write an email to the customer care service centre to escalate the process at step 508. In one embodiment, the complaint list further comprises reference ID allotted while registering the complaint, product name for which the complaint was registered, the date of raising the complaint and the latest status of the complaint.

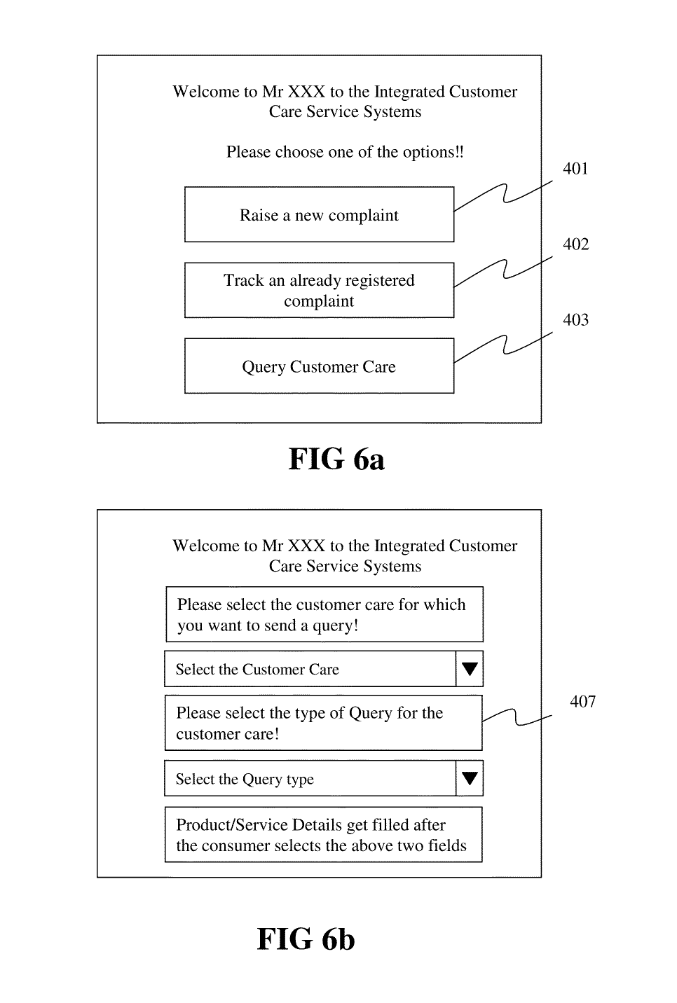

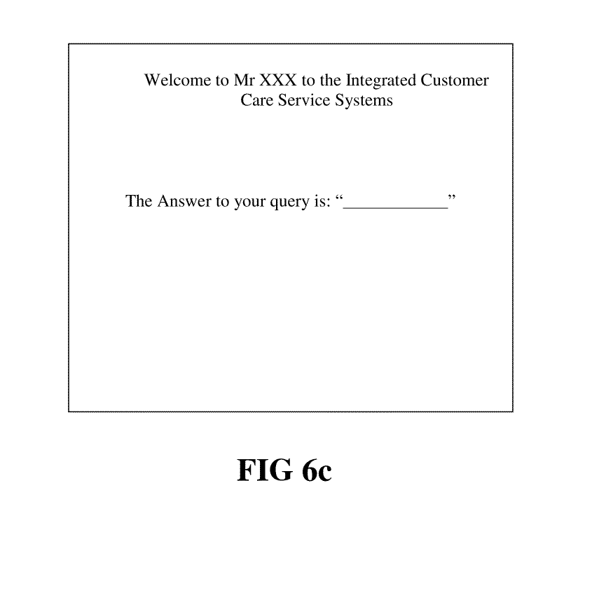

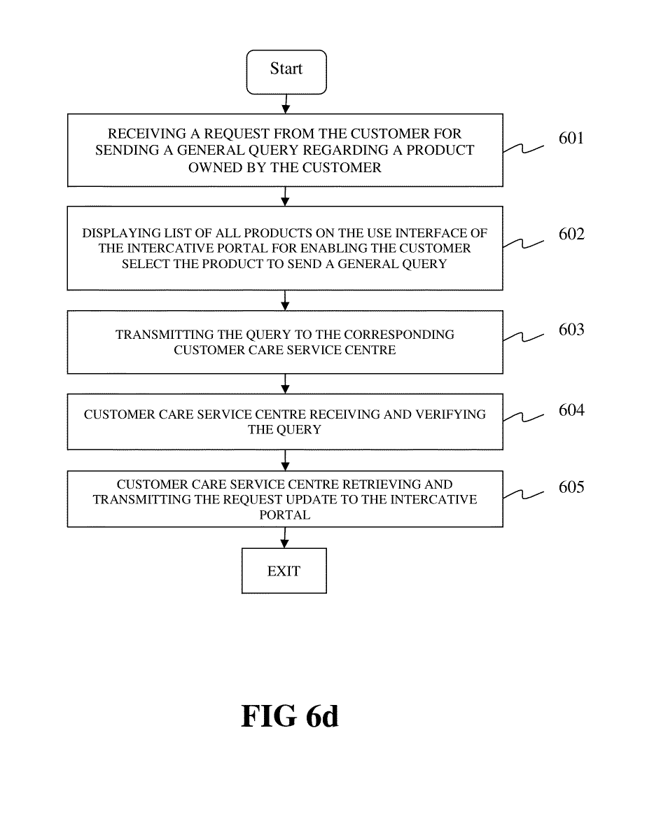

FIG. 6a illustrates an exemplary graphical user interface of the portal presented to the customer for registering a new query with a customer care service centre, according to an exemplary embodiment of the invention. In this embodiment, the platform provides the facility to the registered customer to communicate with the platform and query a customer care service centre regarding a product or service owned by the customer. Upon logging into the platform, the customer may select an option to query a customer care service centre from the “Query customer care” button (403) provided on the user interface.

FIG. 6b illustrates an exemplary graphical user interface of the portal presented to the customer after selecting the query option, according to an exemplary embodiment of the invention. After the customer selects the option to query customer care service centre from the user interface, another menu is displayed to the customer which prompts the customer to input the details such as name of the product and the name of the customer care service centre from a drop down list for which the customer wants to raise a query. The drop down list may be populated from the platform's customer repository. Upon selecting the customer care service centre name, the customer may be prompted to input the query details such as “type of query” (407). The type of query may also be populated from the platform's customer repository. For each customer care service centre a specific set of queries shall be stored in the platform's form repository. After selecting the customer care and the type of query, the relevant details get automatically populated with respective data related to products/services. In another embodiment, the customer may also enter the details relevant to the query which may be used by the customer care service centers and send the answer specific to the customer and relevant for the customer. For e.g. a customer for water purifier may raise a question “In how many days should the maintenance be done?” The question are transmitted to the relevant customer care service centre who verify the customer's product details and find the answer for the question from a question and answer bank maintained by the customer care service centre.

FIG. 6c illustrates an exemplary graphical user interface of the portal presented to the customer after selecting the query option, according to an exemplary embodiment of the invention. After verification, the customer care service centre transmits the reply back to the platform which is displayed on the user interface as shown in the figure.

FIG. 6d illustrates the process flow of the method of sending a general query regarding a product by the customer, according to an exemplary embodiment of the invention. In this embodiment, the platform provides the facility to the registered customer to communicate with the platform and query a customer care service centre regarding a product or service owned by the customer. When the customer selects the option ‘query a customer care service centre’ on the user interface, a request is received by the method for sending a general query regarding a product owned by the customer at step 601. At step 602, a list of all the products is displayed on the user interface of the interactive portal for enabling the customer to select the product or service to send a general query. The customer is prompted to select at least one query from a predefined list and optionally input any other relevant details. At step 603, the query is immediately transmitted to the corresponding customer care service centre belonging to the product manufacturer or service provider. At step 604, the customer care service centre receives and verifies the query. At step 605, the customer care service centre retrieves and transmits the request update to the customer and displays on the user interface of the interactive portal. Thus the customer can see the request update about a previously registered complaint.

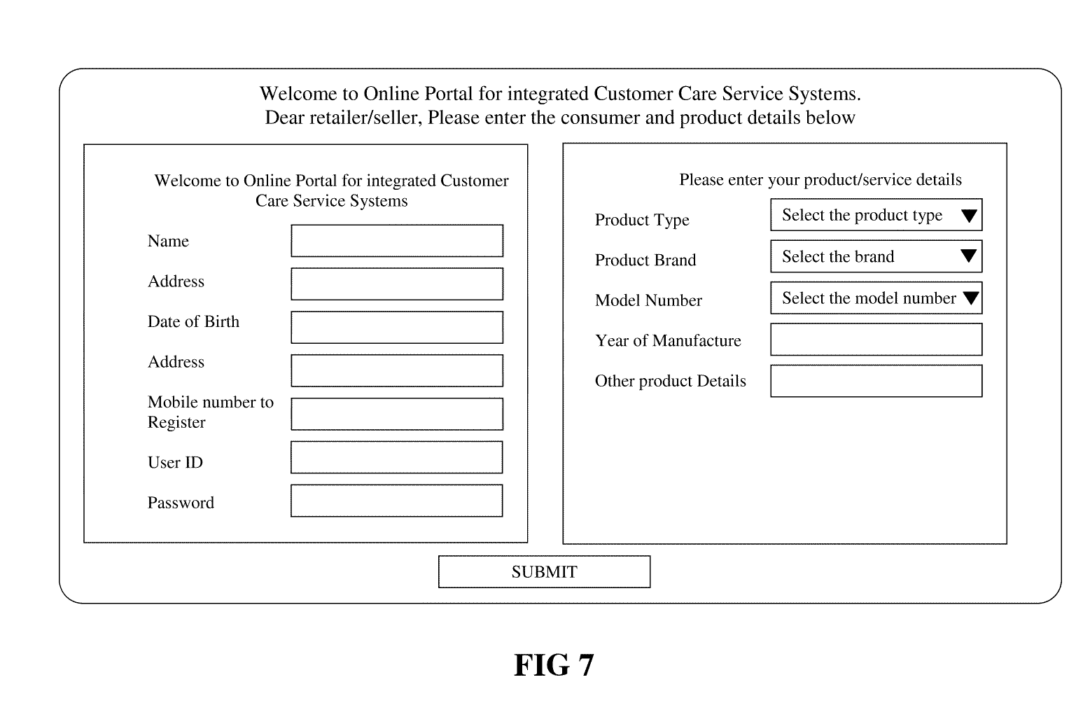

FIG. 7 illustrates an exemplary graphical user interface for enabling retailer/sellers access the system, according to an exemplary embodiment of the invention. In this embodiment, whenever the retailer/seller sells the product/service to the customer, the retailer/seller collects the information such as name, address, date of birth, mobile number, address etc. of the customer. The retailer/seller may fill up a form from the portal, which the retailer/seller may access and provides the customer details and the product details purchased by the customer as shown in the figure and submits it to the platform. The platform also has the facility to perform the validations of the record and store the records in the customer repository.

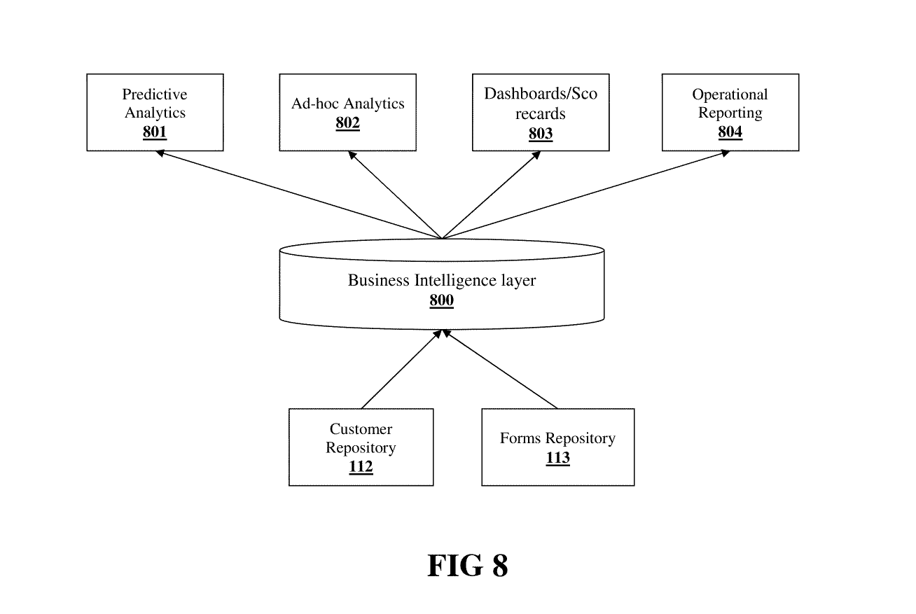

FIG. 8 illustrates block diagram of the business intelligence layer according to an exemplary embodiment of the invention. The business intelligence layer (800) of the customer repository (112) and the forms repository (113) facilitates predictive analytics (801), ad-hoc analytics (802), dashboards and scorecards (803), operational reporting (804) etc apart from other forms of analysis. The platform serves the customer care service providers as a business intelligence layer to conduct analytics work who may use the analytics for a variety of purposes such as:
a. determining the most popular and least popular products or services among customers;
b. determining the products or services having largest incidence of complaints and issues for easy charting of the trends among various categories of the customers;
c. determining the buying behavior of customers belonging to a particular geography, location or demography;
d. designing and developing new product/service ideas based on the analytics;
e. up selling to the customers;
f. providing incentives to the customers for being loyal.

The usage of the present system reduces the overall number of customer care representatives which the service provider employs may be reduced because the manual intervention is avoided or minimized which means lesser financial outflow burden for the organization and less manpower management.

In the invented system, the customer details such as different electrical/electronic appliances in his house and other services subscribed by the customer are stored in the platform. This information may be use by organizations and analysts to study buying behavior, complaint trends and various kinds of analytics that may help organizations develop new products or have product launches on specific markets by geography or demographics. It may spawn further product and service research and development.

It is to be understood, however, that even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms in which the appended claims are expressed.

We claim:

1. A system for integrating plurality of customer care service centres for registering and tracking customer requests using one single platform, the system comprising:
a. a two way interactive portal having graphical user interface, the portal connected to a plurality of customer care service centres via network for direct communication between a customer and the plurality of customer care service centres wherein the portal facilitates the registration and tracking of requests from the customers wherein the requests relate to products, services or event businesses owned by a customer;
b. a customer repository connected to the portal for storing details of the customer, product details and communication details between the customer and the plurality of customer care service systems;
c. a forms repository connected to the portal for storing a form specific to each customer care service centre;
wherein the customer is enabled to directly communicate with plurality of customer care service centre without the need of individually interacting with each customer care service centre for various products and services related complaints and queries.

2. The system as claimed in claim 1 wherein the request from the customer mainly includes at least one of:
a. registration of a new complaint to the customer care service centre by the customer;
b. tracking of complaint previously registered by the customer;
c. sending a general query regarding a product or service by the customer

3. The system as claimed in claim 2 wherein customer posts complaint to the social media platform after registering a complaint with the customer care service centre.

4. The system as claimed in claim 1 wherein the customer registers himself/herself to the system by providing customer details wherein customer details further comprise:
a. customer's name,
b. customer's address;
c. customer's date of birth; or
d. customer's contact number,
wherein customer details are stored in the customer repository.

5. The system as claimed in claim 4 wherein the customer repository stores details related to the products owned by the customer wherein the details related to the product are specific to each product.

6. The system as claimed in claim 1 wherein product also includes services rendered by service providers which are availed by the customer.

7. The system as claimed in claim 2 wherein the customer care service centres participating in the system provide a form specific to the customer care service centre for each request wherein the form is used while transmitting customer request to relevant customer care service system.

8. The system as claimed in claim 4 wherein while transmitting the customer request to the customer care service systems, the form is filled automatically with customer details and product details whereby eliminating the efforts of contacting the different customer care centres for each product and explaining the product details and associated issues etc. which enables the customers with hassle free interaction with various customer care service centres using single platform.

9. The system as claimed in claim 5 wherein the request is forwarded to the relevant customer care service centre in the form specified by each customer care service centre

10. The system as claimed in claim 9 wherein a unique reference ID is generated by the customer care service centre and sent to the customer through the portal.

11. The system as claimed in claim 10 wherein the customer care service centre verifies the request and transmits the request status to the customer.

12. The system as claimed in claim 1 and claim 10 wherein customer repository stores request's reference ID, product details and status of the complaint for each communication between the customer and the customer care service system.

13. The system as claimed in claim 1 wherein a plurality of sellers of products are connected to the system wherein the retailer or seller provide the customer details using the portal and submit to the system.

14. The system as claimed in claim 1 wherein the system further includes a business intelligence layer to conduct analytics work on records from end customer repository and forms repository wherein the analytics are used for at least one of:
a. determining the most popular and least popular products or services among customers;
b. determining the products or services having largest incidence of complaints and issues for easy charting of the trends among various categories of the customers;
c. determining the buying behaviour of customers belonging to a particular geography, location or demography;
d. designing and developing new product/service ideas based on the analytics;
e. up selling to the customers;
f. providing incentives to the customers for being loyal.

15. The system as claimed in claim 1 wherein the system is implemented as a computer application wherein the customer uses the computer application to connect and interact with various customer care service centres through network.

16. The system as claimed in claim 1 wherein the system is implemented as an interactive portal wherein the customer accesses the system using web browser to register, raise and track the previously filed complaints.

17. The system as claimed in claim 1 wherein the computing device includes any device having computing capabilities and a display such as a computer, tablet, smart phone, smart watch, smart camera and smart television.

18. A method of registering and tracking product related requests with plurality of customer care service centres using one single platform, the method comprising the steps of:
a. receiving a request from a customer through interactive portal, having graphical user interface for enabling direct communication between the customer and a plurality of customer care service centres using single platform wherein the request relates to the product owned by the customer;
b. retrieving the customer details and product details from a customer repository;
c. transmitting the request with customer details and product details to the corresponding customer care service centre;
d. receiving the request status from the customer care service centre;
e. transmitting the request status to the interactive portal to display on the user interface,
wherein the customer is enabled to directly communicate with plurality of customer care service centre using one single platform without the need of directly interacting with each customer care service centre related to various products and services.

19. The method as claimed in claim 18 wherein the request comprises at least one of:
a. registering a new complaint to the customer care service centre by the customer;
b. tracking a complaint previously raised by the customer;
c. sending a general query regarding a product by the customer.

20. The method as claimed in claim 19 wherein the customer registers himself/herself by providing customer details wherein customer details further comprise:
a. customer's name,
b. customer's address;
c. customer's date of birth; or
d. customer's contact number,
wherein customer details are stored in the customer repository.

21. The method as claimed in claim 20 wherein the customer repository stores product related details which are specific to each product.

22. The method as claimed in claim 21 wherein product includes services rendered by service providers which are availed by the customer.

23. The method as claimed in claim 19 wherein the step of registering a new complaint further comprises the steps of:
a. receiving a request from the customer for registering a complaint related to a product owned by the customer through the user interface of the interactive portal;
b. displaying a list of all pre configured products on the user interface of the interactive portal for enabling the customer select the product to register a complaint;
c. retrieving and displaying details of the selected product on the user interface of the interactive portal;
d. customer care service centre recording and acknowledging the request by generating a unique reference ID for the request;
e. customer care service centre transmitting the reference ID and request status to the customer;
f. customer care service centre verifying the request and transmitting the reference id and request status to the interactive portal:
g. posting the complaint to the social media platform in case customer wants.

24. The method as claimed in claim 23 wherein the customer care service centres provide a form specific to the customer care service centre for each request wherein the form is used by the platform while transmitting customer request to corresponding customer care service system.

25. The method as claimed in claim 20 wherein customer repository stores request's reference ID, product details and status of the complaint for each communication between the customer and the customer care service centre.

26. The method as claimed in claim 19 wherein the step of tracking a previously raised complaint further comprises the steps of:
a. receiving a request from the customer for tracking a previously registered complaint related to a product owned by the customer;
b. retrieving a complaint list of all the complaints registered by the customer from the customer repository and displaying the complaint list on the user interface for the user to select the complaint to be tracked;
c. transmitting the details of selected complaint to corresponding customer care service centre for request status;
d. customer care service centre receiving and verifying the request;
e. customer care service centre retrieving and transmitting the request status of the complaint to the interactive portal;
i. checking whether the customer is satisfied or not:
in case the customer is satisfied:
exiting the loop;
else
prompting the customer to either resubmit the complaint; or
prompting the customer to write an email to the customer care service centre to escalate the process.

27. The method as claimed in claim 26 wherein the complaint list further comprises:
a. reference ID allotted while registering the complaint;
b. product name for which the complaint was raised;
c. the date of raising the complaint; and
d. the latest status of the complaint.

28. The method as claimed in claim 19 wherein the step of sending a general query regarding a product by the customer further comprises the steps of:
a. receiving a request from the customer for sending a general query regarding a product owned by the customer;
b. displaying a list of all products on the use interface of the interactive portal for enabling the customer select the product to send a general query;
c. transmitting the query to the corresponding customer care service centre;
d. customer care service centre receiving and verifying the query;
e. customer care service centre retrieving and transmitting the request update to the interactive portal.
